(19) United States
(12) Patent Application Publication
(10) Pub. No.: US 2017/0146259 A1
(43) Pub. Date: May 25, 2017

(54) HEATING, VENTILATION AND AIR CONDITIONING (HVAC) CONTROL SYSTEM, HVAC SYSTEM AND CONTROL METHOD

(71) Applicant: Carrier Corporation, Farmington, CT (US)

(72) Inventors: Jianwei Zhao, Shanghai (CN); YuHui Kuang, Shanghai (CN); Qiang Li, Shanghai (CN)

(21) Appl. No.: 15/323,502

(22) PCT Filed: Jun. 25, 2015
(86) PCT No.: PCT/US2015/037577

§ 371 Date: Jan. 3, 2017

(30) Foreign Application Priority Data
Jul. 4, 2014 (CN) 201410316023.3

(51) Int. Cl. F24F 11/00; G05B 15/02

(52) U.S. Cl. CPC F24F 11/0012; G05B 15/02; F24F 11/006; F24F 11/0086; F24F 11/0034; F24F 2011/0063

(57) ABSTRACT

The present invention relates to a Heating, Ventilation and Air Conditioning (HVAC) control system, an HVAC system and control method. The HVAC control system includes an automatic control module, a data acquisition module for monitoring in real time a target region of the HVAC and obtaining acquired data, a data analysis module and a data storage module, wherein the data analysis module receives and analyzes acquired data from the data acquisition module to determine a real-time air conditioning demand situation of a target region, the data storage module stores a historical air conditioning demand situation for being read by the data analysis module, and the automatic control module is in communication with and controls the other modules, and configures air conditioning parameters of the HVAC with reference to the real-time air conditioning demand situation and the historical air conditioning demand situation.

### TECHNICAL FIELD

The present invention relates to the field of heating, ventilating and air conditioning technology, and more particularly, to a Heating, Ventilation and Air Conditioning (HVAC) control system, and further to an HVAC system and control method using the control system.

### BACKGROUND ART

Heating, Ventilation and Air Conditioning (HVAC) refers to a system or a related device responsible for heating, ventilating and air conditioning within a building or vehicle. The HVAC system can regulate and control air temperature, humidity, cleanness, velocity, pressure, and other parameters, thereby improving the comfort of a target space, especially playing a very important role in medium-to-large industrial buildings or office buildings (such as skyscrapers). In addition, the HVAC also plays a very significant role in the areas and industries such as pharmaceuticals, electronics, and oil and gas.

In the current building automation system in intelligent buildings, the HVAC is a key composing part. Generally speaking, the HVAC system in the buildings may be switched manually or switch controlled based on a preset time interval. Typical cases include those in office buildings and shopping malls. In the office buildings, the HVAC in office region is usually controlled through computer programs or master switches according to the work time, and switch, temperature, humidity, cleanness, velocity, and other parameters of a corresponding air outlet are configured according to specific needs at a specific office location during the work time; and most of shopping malls also adopt the similar control.

In view of the above, the HVAC system in the current intelligent buildings is mainly switched and air-conditioned manually and controlled by an automatic switch at a scheduled interval. It is not “smartly” air-conditioned based on the effective usage of an objective space in a building automatic control system, thus failing to satisfy the demand for system optimization and energy saving.

### SUMMARY OF THE INVENTION

The technical problem to be solved by the present invention is to provide a Heating, Ventilation and Air Conditioning (HVAC) control system that can overcome the aforementioned defects in the prior art. Furthermore, the present invention further provides an HVAC system and control method using the control system.

In order to address the aforementioned technical problem, a first aspect of the present invention provides an HVAC control system, comprising an automatic control module, and:

a data acquisition module, configured to monitor in real time a target region of the HVAC and to obtain acquired data;

a data analysis module and a data storage module, the data analysis module receiving the acquired data from the data acquisition module and analyzing the acquired data to determine a real-time air conditioning demand situation of the target region, and the data storage module storing a historical air conditioning demand situation for being read by the data analysis module;

wherein, the automatic control module is in communication with and controls the data acquisition module, the data analysis module, and the data storage module, and configures air conditioning parameters of the HVAC with reference to the real-time air conditioning demand situation and the historical air conditioning demand situation.

Optionally, in the aforementioned control system, the data acquisition module is a shooting device including a camera or a webcam.

Optionally, in the aforementioned control system, the data storage module stores a workday mode and a holiday mode, the workday mode serving as a basis for the automatic control module to control the HVAC on workdays, and the holiday mode serving as a basis for the automatic control module to control the HVAC on holidays.

Optionally, in the aforementioned control system, the data storage module stores a workday mode and a holiday mode, the workday mode serving as a basis for the automatic control module to control the HVAC on workdays; the control system further includes a manual control module, and the HVAC is not turned on in the holiday mode by default, while the air conditioning parameters of the HVAC is configured through the manual control module.

Optionally, in the aforementioned control system, the workday mode is: when a matching degree between the real-time air conditioning demand situation and the historical air conditioning demand situation does not exceed a preset error or a preset range, configuring the air conditioning parameters of the HVAC by using historical HVAC configuration data; and when the matching degree between the real-time air conditioning demand situation and the historical air conditioning demand situation exceeds the preset error or the preset range, configuring the air conditioning parameters of the HVAC according to the real-time air conditioning demand situation.

In order to address the aforementioned technical problem, a second aspect of the present invention provides an HVAC system, comprising the control system according to any item of the aforementioned first aspect.

In order to address the aforementioned technical problem, a third aspect of the present invention provides a method for controlling an HVAC through an HVAC control system, the HVAC control system including:

a data acquisition module, configured to monitor in real time a target region of the HVAC and to obtain acquired data;

a data analysis module and a data storage module, the data analysis module receiving the acquired data from the data acquisition module and analyzing the acquired data to determine a real-time air conditioning demand situation of the target region, and the data storage module storing a historical air conditioning demand situation for being read by the data analysis module;

an automatic control module, being in communication with and controlling the data acquisition module, the data analysis module, and the data storage module,

wherein, the automatic control module configures air conditioning parameters of the HVAC with reference to the real-time air conditioning demand situation and the historical air conditioning demand situation.

Optionally, in the aforementioned method, the data acquisition module is a shooting device including a camera or a webcam.

Optionally, the aforementioned method includes two control modes, namely a workday mode and a holiday mode; whether the current date is a workday or a holiday is firstly determined before the HVAC is turned on, the workday mode is activated when the current date is the workday; and the holiday mode is activated when the current date is the holiday.

Optionally, the aforementioned method includes, in the workday mode, firstly configuring conditioning parameters of the HVAC based on historical HVAC configuration data, then comparing the real-time air conditioning demand situation with the historical air conditioning demand situation, and if the matching degree thereof exceeds a preset error or a preset range, configuring the conditioning parameters of the HVAC by using the real-time air conditioning demand situation.

Optionally, in the aforementioned method, the control system further includes a manual control module,

wherein the automatic control module does not turn on the HVAC by default in the holiday mode, and the air conditioning parameters of the HVAC is configured through the manual control module.

Optionally, in the aforementioned method, the HVAC further includes an air exchange device, distributed at the target region as demanded to exchange the conditioned air within the HVAC to the target region, and the control system further includes an on-site manual switch installed in the target region for configuring the conditioning parameters of the air exchange device.

Optionally, in the aforementioned method, the automatic control module configures the time for turning on and off the HVAC based on the historical air conditioning demand situation, and sets air conditioning parameters of the HVAC in accordance with common configurations of the manual switch.

Optionally, in the aforementioned method, the historical air conditioning demand situation is based on a work time regularity configuration within the target region obtained by analyzing the acquired data of the data acquisition device.

Optionally, in the aforementioned method, the historical HVAC configuration data is corresponding to data of an average value of a flow rate of people in each period within a set number of days in history or is corresponding to data of a flow rate of people with a maximum probability in each period within a set number of days in history.

Optionally, in the aforementioned method, in the workday mode, indicators adopted for comparing the real-time air conditioning demand situation with the historical air conditioning demand situation include the flow direction and quantity of people within the target region.

It can be understood from the above description that, the present invention uses automatic HVAC pre-configuration of a monitor device to achieve a better energy saving effect and make up for the control optimization on a conventional HVAC system, which can be applied to the cases of office buildings, shopping malls, and the like, and in a more advanced manner, to a private booking system for VIP rooms, so as to provide a comfortable environment as expected by customers.

### DESCRIPTION OF THE DRAWINGS

With reference to the accompanying drawings, the content disclosed by the present invention will become more apparent. It should be understood that, these drawings are only for illustrative purposes, but are not intended to limit the protection scope of the present invention. In the figures:

FIG. 1 is a schematic block diagram of an HVAC control system according to an embodiment of the present invention; and

FIG. 2 is a schematic flowchart of a method for controlling an HVAC through an HVAC control system according to an embodiment of the present invention.

### DETAILED DESCRIPTION OF THE EMBODIMENTS

Hereinafter, with reference to the drawings, specific embodiments of the present invention are described in detail.

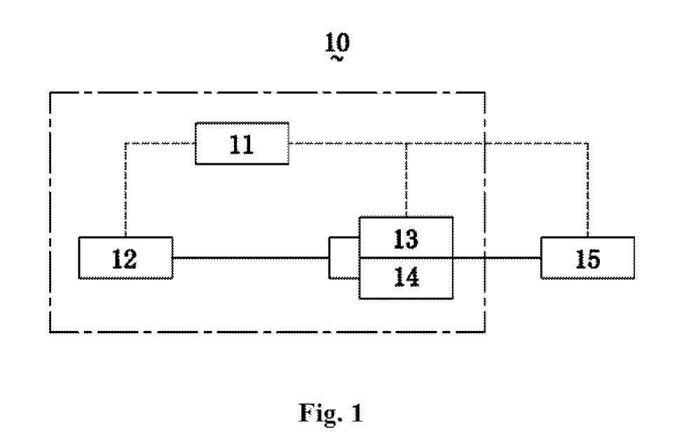

FIG. 1 is a schematic block diagram of an HVAC control system according to an embodiment of the present invention. As can be seen from FIG. 1, the HVAC control system 10 in this embodiment may include an automatic control module 11, a shooting module 12, a data analysis module 13, and a data storage module 14, to control HVAC 15. It can be understood that the term “module” herein may refer to a different functional sub-region within the control system or equipment or indicate a different device or member within the control system or equipment. For the sake of clarity, the block diagram is merely used for illustration but omits other details of each module.

In the illustrated embodiment, the shooting module 12 is a data acquisition module, configured to shoot a target region of the HVAC 15 in real time and to obtain captured data, and information for determining the air conditioning demand situation of the target region such as number of people, personnel changes, flow rate of people, and flow direction of people can be known by analyzing the captured data including photos (image data) or videos. Technical persons skilled in the art have mastered the technology of obtaining the aforementioned information through photos or videos. It can be appreciated that the shooting module 12 in this embodiment is merely one of a variety of acquisition modules (a device for acquiring the information of the air conditioning demand situation in the target region of the HVAC). For example, various sensors, instead of the shooting module, can be used as the data acquisition module to determine the real-time air conditioning demand situation. In the present invention, the real-time air conditioning demand situation is used as one of the parameters for controlling the HVAC, which can provide a more comfortable environment for the target region, and facilitate adjusting control policies in real time, thereby achieving energy saving.

Herein, the “target region” refers to the regions in need of HVAC for air conditioning, which for example includes, but is not limited to, the regions such as office buildings, shopping malls, conference and other commercial activity occasions, and VIP rooms, and can also include factory workshops, equipment rooms, and animal farming rooms in need of air conditioning; alternatively, the “target region” can also especially refer to a plurality of sub-regions in the aforementioned regions (for example, office buildings can be divided into a number of office floors, the office floors can be further divided into a number of office regions, and each of the office regions can be further divided into a plurality of segments corresponding to different scavenging ports), for refining control settings, and meeting the air conditioning needs of different regions. In these target regions, HVAC parameters that need to be adjusted may include, but are not limited to, one or more of the air conditioner switch, air temperature, humidity, cleanness, air velocity, and pressure. Accordingly, air conditioning state signals, temperature sensors, humidity sensors, air cleanness sensors, air flow rate sensors, and the like can be for example used as a data acquisition module in place of the shooting module in the illustrated embodiment to directly determine the air conditioning demand situation in the target region, thereby achieving the control on the target region in real time.

In the context of the present application, unless otherwise stated, only the example in which an office region in a building is taken as the “target region” and only the example in which the shooting module is taken as the device for obtaining the air conditioning demand situation are taken for illustration, so that persons skilled in the art can appreciate the principle of the present invention more clearly. With reference to the description of the context of the present application, persons skilled in the art can appreciate optional embodiments of other forms of target region and device for obtaining the air conditioning demand situation.

The data analysis module 13, which may be in communication with the shooting module 12 and the data storage module 14 in a wired manner or in a wireless manner, is capable of receiving shooting data from the shooting module 12 and analyzing the data to determine the real-time air conditioning demand situation of the target region. The data storage module 14, which may also be in communication with the shooting module 12 and the data analysis module 13, may store analysis data related with the historical air conditioning demand situation that can be read by the data analysis module 13. Such a control manner can achieve two objectives of energy saving and degree of comfort of the target region at the same time, thereby being suitable for being applied in modern office buildings. For example, the data analysis module may obtain photo or video data at different time points from a monitor webcam (the shooting module) in an office region, make an analysis to obtain statistics on evaluation of flow rate of people and historical data in the office region, and store the corresponding data in the data storage module to be read and invoked by the data analysis module and the automatic control module. How to obtain the information of flow rate of people by analyzing photo and video data in the prior art can be understood by persons skilled in the art, thus being not repeated in detail herein.

In an optional embodiment, the data analysis module 13 and the data storage module 14 may be a processor and a storage of a computer system, which are advanced in technique and require no additional design, so as to achieve convenience, a high efficiency, and a high cost benefit. In addition, the data analysis module and the data storage module may also be integrated into the same module. It can be appreciated that, through such integration, space cost can be saved and work stability can be enhanced during manufacturing.

The automatic control module 11 is in communication with and controls the data acquisition module 12, the data analysis module 13, and the data storage module 14, and configures air conditioning parameters of the HVAC 15 with reference to the real-time air conditioning demand situation and the historical air conditioning demand situation. Persons skilled in the art can understand that the requirement on air conditioning in various target regions can be satisfied by combining the real-time air conditioning demand situation and the historical air conditioning demand situation in various manners. For example, in the case of a 24-hour running equipment room for example, the air conditioning parameters of the HVAC are normally configured based on the historical air conditioning demand situation; in certain cases, if the temperature and humidity in the equipment room are found abnormal by analyzing the information obtained by a temperature sensor or a humidity sensor serving as the device for obtaining the air conditioning demand situation, temperature or humidity parameters of the HVAC are re-configured through the automatic control module based on the real-time air conditioning demand situation. For another example, in the cases with requirement on air cleanness, a cleanness parameter of air conditioning can be normally configured based on the historical air conditioning demand situation; if it is found abnormal upon analysis on the data of cleanness sensors, the cleanness parameter of the HVAC is re-configured by the automatic control module based on the real-time air conditioning demand situation.

In the case of an office region in an office building, when the air conditioning parameters are configured based on the historical air conditioning demand situation, the automatic control system may perform automatic control and adjustment on the HVAC parameters at different time points or in different time period in accordance with a historical control regularity based on the historical data in the data storage module. Such a control mode has a high regularity which can facilitate the planning of energy application, thereby avoiding excessive energy consumption caused by fluctuation of control. Herein, different methods for making statistics on the historical data can also be provided. For example, the methods may include, but are not limited to, calculating an average value of a flow rate of people in each time period within a preset number of days in history as the historical data for reference; or calculating data with a maximum probability of a flow rate of people in each time period within a preset number of days in history as the historical data for reference. These two statistics methods both take ensuring the average or most cases of air conditioning requirement as possible into consideration, to meet the satisfaction of the personnel in the target region. It can be understood that, at the same time when the automatic control is completed, the system updates the control data on the current date into the data storage module for being read as the historical data and taken as reference, thereby further optimizing the control policy.

In the case where the target region is an office region, the control over the HVAC on workdays and holidays can be set into different modes, namely a workday mode and a holiday mode. These control modes can be stored in the data storage module.

The workday mode may be taken as a basis for the automatic control module to control the HVAC on workdays. In the workday mode, the automatic control module firstly configures the parameters such as switch, temperature, and air volume of the air conditioner based on the historical data. These historical data indicate the air conditioning demand situation in the case of normal workdays, i.e., when the workday mode is activated, it is firstly considered by default that the current date is a normal workday, and a normal air conditioning requirement in the office region is met; meanwhile, the historical data of people flow (that is the historical air conditioning demand situation) is compared with the real-time data of people flow (that is the real-time air conditioning demand situation). If they are not matched with each other, it indicates that exceptional cases exist on the current date, including activities other than the normal office work or the current date being an exceptional holiday, parameters of the air conditioner are configured automatically based on the real-time flow rate of people (obtained by analyzing in real time the data captured by the shooting module), so as to meet the air conditioning requirement during activities or to reduce the load of the air conditioner, thereby saving energy. Herein, the compared data may include two types, namely the flow direction of people and the quantity of people. For example, the flow direction of people may include, but is not limited to, enter, pass through, wander, and quit; and the quantity of people may be classified into low, moderate, and high levels or low, moderate low, moderate, moderate high, and high levels, and may also adjusted into other more levels to refine the classification. When the matching degree between the real-time flow direction of people and quantity of people and the historical data exceeds a preset error or a preset range, an activity setting or an exception setting is activated to configure the parameter of the HVAC according to the real-time situation. In view of the above, the workday mode in this embodiment is set as: when the matching degree between the real-time air conditioning demand situation and the historical air conditioning demand situation does not exceed the preset error or the preset range, configuring the air conditioning parameters of the HVAC by using historical HVAC configuration data; and when the matching degree between the real-time air conditioning demand situation and the historical air conditioning demand situation exceeds the preset error or the preset range, configuring the air conditioning parameters of the HVAC according to the real-time air conditioning demand situation. For example, when multiple fine levels are defined, if the corresponding level of the historical air conditioning demand situation is a moderate high level, and the corresponding level of the real-time air conditioning demand situation is a moderate or high level adjacent to the moderate high level, it is unnecessary to re-configure the HVAC only if the matching degree thereof does not exceeds the preset error or the preset range, so as to avoid the situation that the HVAC work state is changed all the time to go against the principle of energy saving. The preset error or the preset range can be selected based on experiences or through multiple debugging on the system.

The holiday mode may be taken as a basis for the automatic control module to control the HVAC on holidays, to facilitate energy saving as much as possible. Since there is usually less or no working staff in the target region during the holiday, the HVAC is not activated by default in the holiday mode. However, the HVAC control system may further be provided with a manual control module for special needs. In this way, in the holiday mode, the automatic control module is not used to activate the HVAC by default, but the manual control module can be used to turn on the air conditioner and configure the air conditioning parameters of the HVAC.

It is well known to all that, the HVAC includes an air exchange device distributed in the target region as needed, for exchanging the air conditioned in the HVAC to the target region. A common air exchange device includes an indoor unit and an air outlet of an air conditioner, and the like. In order to make the air output parameter of the air conditioner better meet the requirement of the target region, the control system may further include an on-site manual switch installed in the target region for configuring the conditioning parameters of the air exchange device. In this way, in the case where the HVAC has been turned on, the personnel in the target region may directly adjust all the parameters including air temperature, humidity, and air volume according to actual demands, which is convenient and fast.

Viewed as a whole, FIG. 1 is an HVAC system including the HVAC control system 10. The HVAC system of the present invention may include the aforementioned HVAC 15 and the aforementioned HVAC control system 10, the control system controlling the operation of the HVAC.

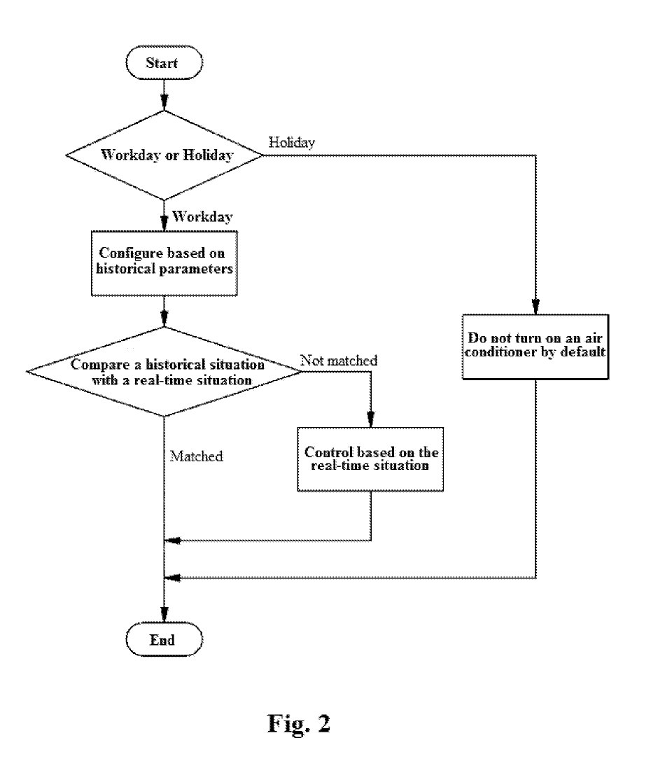

FIG. 2 is a schematic flowchart of a method for controlling an HVAC through an HVAC control system according to an embodiment of the present invention. The method for controlling the HVAC in the embodiment adopts an HVAC control system which includes a data acquisition module (for example, a shooting module), a data analysis module and a data storage module, and an automatic control module, and may further include a manual control module and so on, as can be referred to FIG. 1 for example. It can be understood that, the method for controlling in the embodiment may also achieve the control over the HVAC through the control system shown in FIG. 1. The automatic control module, the data acquisition module, the data analysis module, the data storage module, and the like can be referred to the description above, thus being not repeated herein in detail.

The method of the embodiment as described above includes two control modes, namely a workday mode and a holiday mode, whether the current date is a workday or a holiday is firstly determined before the HVAC is turned on, and the workday mode is activated when the current date is the workday, and the holiday mode is activated when the current date is the holiday. Workday information and holiday information may be input to the system by relevant personnel in advance, thus being not repeated herein in detail. In the workday mode, the conditioning parameters of the HVAC are firstly configured based on the historical HVAC configuration data, then the real-time air conditioning demand situation is compared with the historical air conditioning demand situation, and if the matching degree thereof exceeds a preset error or a preset range, the air conditioning parameters of the HVAC are configured by using the real-time air conditioning demand situation. The control system further includes a manual control module, and the automatic control module does not turn on the HVAC by default in the holiday mode, and the air conditioning parameters of the HVAC are configured through the manual control module. More detailed description about such control method may refer to the relevant description above.

The present invention may further provide a special control over VIP rooms. For example, the automatic control module may configure the time for turning on and off the HVAC in the VIP rooms based on the historical air conditioning demand situation of the VIP rooms, for example, it may advance (or postpone) the time for turning on the air conditioner in the VIP rooms, postpone (or advance) the time for turning off the air conditioner in the VIP rooms, and set the air conditioning parameters of the HVAC according to common configurations of the manual switch. In such a VIP room customization service, the historical air conditioning demand situation may learn an VIP's work time regularity configuration by analyzing the acquired data such as photos or videos, the air conditioner is turned on before the VIP enters the room, presetting is done according to the common configurations of the HVAC of the VIP, and the air conditioner is turned off automatically after the VIP leaves the room.

The aforementioned description on the preferred embodiments of the present invention with reference to the accompanying drawings is merely exemplary and illustrative; persons skilled in the art can also make changes or modifications of an equivalent or similar form on the preferred embodiments of the present invention under the teaching given herein, and these changes or modifications will also fall within the protection scope covered by the claims of the present invention.

1. A Heating, Ventilation and Air Conditioning (HVAC) control system, characterized in that the HVAC control system comprises an automatic control module, and:
a data acquisition module, configured to monitor in real time a target region of the HVAC and to obtain acquired data;
a data analysis module and a data storage module, the data analysis module receiving the acquired data from the data acquisition module and analyzing the acquired data to determine a real-time air conditioning demand situation of the target region, and the data storage module storing a historical air conditioning demand situation for being read by the data analysis module;
wherein, the automatic control module is in communication with and controls the data acquisition module, the data analysis module, and the data storage module, and configures air conditioning parameters of the HVAC with reference to the real-time air conditioning demand situation and the historical air conditioning demand situation.

2. The control system according to claim 1, wherein the data acquisition module is a shooting device comprising a camera or a webcam.

3. The control system according to claim 1, wherein the data storage module stores a workday mode and a holiday mode, the workday mode serving as a basis for the automatic control module to control the HVAC on workdays, and the holiday mode serving as a basis for the automatic control module to control the HVAC on holidays.

4. The control system according to claim 1, wherein the data storage module stores a workday mode and a holiday mode, the workday mode serving as a basis for the automatic control module to control the HVAC on workdays; the control system further comprises a manual control module, the HVAC is not turned on in the holiday mode by default, but the air conditioning parameters of the HVAC are configured through the manual control module.

5. The control system according to claim 3, wherein the workday mode is: when a matching degree between the real-time air conditioning demand situation and the historical air conditioning demand situation does not exceed a preset error or a preset range, configuring the air conditioning parameters of the HVAC by using the historical HVAC configuration data; and when the matching degree between the real-time air conditioning demand situation and the historical air conditioning demand situation exceeds the preset error or the preset range, configuring the air conditioning parameters of the HVAC according to the real-time air conditioning demand situation.

6. An HVAC system, characterized in that the HVAC system comprises the control system according to claim 1.

7. A method for controlling an HVAC through an HVAC control system, characterized in that the HVAC control system comprises:
a data acquisition module, configured to monitor in real time a target region of the HVAC and to obtain acquired data;
a data analysis module and a data storage module, the data analysis module receiving the acquired data from the data acquisition module and analyzing the acquired data to determine a real-time air conditioning demand situation of the target region, and the data storage module storing a historical air conditioning demand situation for being read by the data analysis module; and
an automatic control module, being in communication with and controlling the data acquisition, the data analysis module, and the data storage module,
wherein, the automatic control module configures air conditioning parameters of the HVAC with reference to the real-time air conditioning demand situation and the historical air conditioning demand situation.

8. The method according to claim 7, wherein the data acquisition module is a shooting device comprising a camera or a webcam.

9. The method according to claim 7, wherein the method comprises two control modes, namely a workday mode and a holiday mode;
firstly determining whether the current date is a workday or a holiday before turning on the HVAC, activating the workday mode when the current date is the workday; and activating the holiday mode when the current date is the holiday.

10. The method according to claim 9, wherein, in the workday mode, firstly configuring the conditioning parameters of the HVAC based on historical HVAC configuration data, and then comparing the real-time air conditioning demand situation with the historical air conditioning demand situation, and if the matching degree thereof exceeds a preset error or a preset range, configuring the conditioning parameters of the HVAC by using the real-time air conditioning demand situation.

11. The method according to claim 9, wherein the control system further comprises a manual control module,
the automatic control module does not turn on the HVAC by default in the holiday mode, and the air conditioning parameters of the HVAC are configured through the manual control module.

12. The method according to claim 7, wherein the HVAC further comprises an air exchange device, distributed at the target region as demanded to exchange the conditioned air within the HVAC to the target region, and the control system further comprises an on-site manual switch installed in the target region for configuring the conditioning parameters of the air exchange device.

13. The method according to claim 12, wherein the automatic control module configures the time for turning on and off the HVAC based on the historical air conditioning demand situation, and sets the air conditioning parameters of the HVAC in accordance with common configurations of the manual switch.

14. The method according to claim 13, wherein the historical air conditioning demand situation is based on a work time regularity configuration within the target region obtained by analyzing the acquired data of the data acquisition device.

15. The method according to claim 10, wherein, the historical HVAC configuration data is corresponding to data of an average value of a flow rate of people in each period within a set number of days in history or is corresponding to data of a flow rate of people with a maximum probability in each period within a set number of days in history.

16. The method according to claim 10, in the workday mode, indicators adopted for comparing the real-time air conditioning demand situation with the historical air conditioning demand situation comprise the flow direction and quantity of people within the target region.
